(19) United States
(12) Patent Application Publication
(10) Pub. No.: US 2005/0284008 A1
(43) Pub. Date: Dec. 29, 2005

(54) Foldable bib display apparatus

(76) Inventors: Kim Hayes, Rockford, MI (US); Mike Lavine, Round Lake, IL (US)

Correspondence Address: Philip H. Gottfried, Esq.;Amster, Rothstein & Ebenstein LLP, 90 Park Avenue, New York, NY, 10016, US

(21) Appl. No.: 10/875,648

(22) Filed: Jun. 24, 2004

(51) Int. Cl. G09F 3/00

(52) U.S. Cl. 40/322

(57) ABSTRACT

A foldable bib display apparatus for holding and displaying a bib comprises two or more foldably connected means for holding respective portions of the bib, a hanger means in the form of, for example, a “J”-shaped opening or a hook for positioning the foldable bib display apparatus holding a bib in a folded condition in a display space, and a frontal area for displaying information, such as an illustration. When folded, the foldable bib display apparatus holds a bib in a folded condition, thereby minimizing the display space for the bib. The present invention also permits repeated un-folding and re-folding of the bib to facilitate prospective customer's inspection of the bib in its unfolded condition and return of the bib to the display space by the inspecting prospective customer or a shop employee.

### FIELD OF THE INVENTION

The present invention relates generally to a garment display apparatus. In particular, the present invention relates to a foldable bib display apparatus that fits into or clamps onto a bib or the like, holds the bib for compact display in its folded condition, and can be unfolded and re-folded by an inspecting prospective customer.

### BACKGROUND OF THE INVENTION

Typically, bibs have been displayed in stores either in unfolded condition or as packaged in folded or rolled condition. For example, a typical conventional bib display apparatus would hang a bib and displays it horizontally in its unfolded condition. The display of a bib using such conventional bib display apparatus takes up the full horizontal width of the bib in display space or wall space. It is often desirable to minimize the display space or wall space taken up by the display of bibs. Accordingly, an object of the present invention is to minimize the display space or wall space taken up by the display of bibs by providing a foldable bib display apparatus capable of folding the bib that it holds, for example, substantially in half, and displaying it in its folded condition.

Furthermore, even if bibs were to be packaged in folded or rolled condition for display so as to save display space or wall space, there is also a desire and need to allow easy unfolding or unrolling of the bibs in display when unmounted from the display rack so that a customer can view the bib in its fully unfolded condition. However, prior to the present invention, there was no bib display apparatus capable of repeated folding and unfolding of the bib so as to permit savings in display space without sacrificing the convenience to customers in inspecting the bibs in their unfolded condition. Hence, another object of the present invention is to provide a foldable bib display apparatus that allows easy unfolding when unmounted from the display rack or unpositioned from the display space for inspection so as to facilitate viewing of the bib in its fully unfolded condition by an inspecting prospective customer. Yet another object of the present invention is to provide a foldable bib display apparatus that permits easy re-folding of the bib for re-mounting onto the display rack or re-positioning in the display space after the prospective customer's inspection so that the display space or wall space taken up by the display of the bib is minimized as before the inspection.

Still another object of the present invention is to provide a foldable bib display apparatus capable of being mounted onto the display rack or wall, or otherwise positioned in the display space, in its folded condition.

Yet still another object of the present invention is to provide a foldable bib display apparatus that includes an area for displaying information such as product information or features, advertisement, or a picture of the bib in its unfolded condition.

Other objects and advantages of the present invention will become apparent from the following description.

### SUMMARY OF THE INVENTION

It has now been found that the above and related objects of the present invention are obtained in the form of several related aspects, including a foldable display apparatus for a garment such as a bib or a T-shirt.

A bib display apparatus of the present invention for holding and displaying a bib in a folded condition to minimize display space for the bib comprises a means for holding the bib, which is capable of holding the bib in both folded and unfolded condition, a means for permitting repeated folding and unfolding of the bib held by the means for holding so as to facilitate display and inspection of the bib, and a means for positioning the bib in a folded condition in display space. In place of a bib, a foldable display apparatus having the same or similar structure may be used for holding and displaying any foldable, substantially flat garment, such as a T-shirt, in a folded condition to minimize display space for the garment.

The bib display apparatus may further comprise a means for displaying information, such as an illustration. The means for displaying information may comprise a frontal area of a portion of the bib display apparatus.

The means for holding the bib may be designed to hold the bib either horizontally or vertically. The means for holding the bib may comprise a plurality of foldably connected means for holding their respective portions of the bib, wherein the means for permitting repeated folding and unfolding may then comprise foldable connections affixed between the plurality of the foldably connected means for holding their respective portions of the bib. The foldable connections may comprise one or more mechanical hinges. The means for permitting repeated folding and unfolding may be designed to fold the bib along one folding line, or two or more folding lines.

The means for holding the bib may comprise, for example, one or more clips, or one or more hook-and-loop fasteners such as Velcro-type fasteners. The means for positioning the bib may comprise hanger means, such as one or more hooks, or an opening (e.g., a “J”-shaped opening) in the means for holding the bib.

A foldable bib display apparatus of the present invention for holding and displaying a bib in a folded condition to minimize display space for the bib comprises a first means for holding a first portion of the bib, a second means for holding a second portion of said bib, and a hanger means for positioning said foldable bib display apparatus in folded condition for display, wherein the first means and the second means for holding their respective portions of the bib are foldably connected to each other so that the foldable bib display apparatus when folded can hold and display the bib in a folded condition and can be repeatedly unfolded to facilitate inspection of the bib and re-folded for return to display by a prospective customer or a store employee.

The first and second means for holding their respective portions of the bib may be designed to hold their respective portions of the bib either horizontally or vertically. These first and second means for holding their respective portions of the bib may be foldably connected by one or more hinges. These means for holding the respective portions of the bib may comprise, for example, one or more clips or one or more hook-and-loop fasteners such as Velcro-type fasteners. The hanger means may comprise, for example, one or more hooks or an opening, such as a “J”-shaped opening, in at least one of the first and the second means for holding their respective portions of the bib.

The foldable bib display apparatus may further comprise a frontal area for displaying information, such as an illustration, on a portion of the apparatus.

The foldable bib display apparatus may further comprise a third means for holding a third portion of the bib, which is foldably connected to one or more of the first means and the second means for holding their respective portions of the bib so that the foldable bib display apparatus when folded can hold and display the bib in a folded condition and can be repeatedly unfolded to facilitate inspection and re-folded to facilitate return to display by a prospective customer or a store employee.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 is a front view of a foldable bib display apparatus in unfolded condition in one possible embodiment of the present invention, which is designed to hold a bib horizontally;

FIG. 2 illustrates a front view of the foldable bib display apparatus of FIG. 1 holding a bib, still in unfolded condition;

FIG. 3 illustrates a front view of the foldable bib display apparatus of FIG. 1 displaying the bib of FIG. 2 in its folded condition and positioned in display space;

FIG. 4 is a front view of a foldable bib display apparatus in unfolded condition in alternate embodiment of the present invention, which is designed to hold a bib vertically;

FIG. 5 illustrates a front view of the foldable bib display apparatus of FIG. 4 holding a bib, still in unfolded condition; and

FIG. 6 illustrates a front view of the foldable bib display apparatus of FIG. 4 displaying the bib of FIG. 5 in its folded condition and positioned in display space.

### DETAILED DESCRIPTION OF THE INVENTION

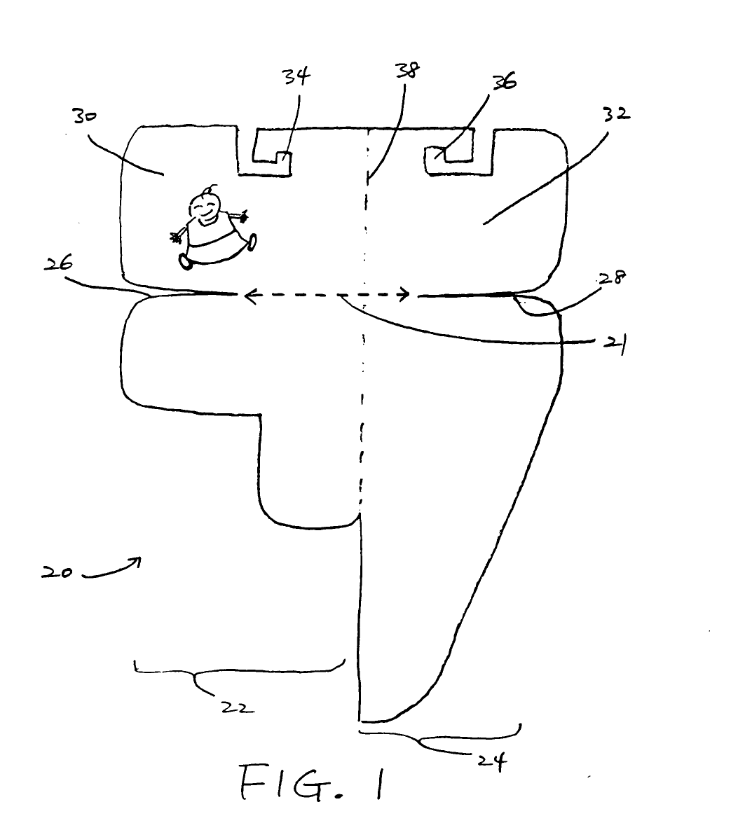

Referring now to FIG. 1 containing a front view of one embodiment of the present invention, a foldable bib display apparatus designed to hold and display a bib in its horizontal orientation is shown in unfolded condition and is generally designated by the reference numeral 20. The foldable bib display apparatus 20 comprises a first support 22 for holding a horizontal half of the bib. The first support 22 is foldably connected at a folding line 38 to a side of a second support 24 for holding the other horizontal half of the bib. Preferably, the connecting part between these two supports 22, 24 at the folding line 38 is capable of withstanding repeated folding and unfolding at the folding line 38. For example, the first and second supports 22 and 24 may be made out of a single sheet of durable cardboard paper, a plastic sheet, or any other durable material capable of withstanding repeated folding and unfolding. Alternatively, a mechanical hinge of conventional design may be connected to supports 22 and 24 and used at the folding line 38 to foldably connect these two supports 22 and 24.

While FIG. 1 shows a pair of the supports 22, 24 comprising a single, contiguous plane made out of the same material, the supports of the present invention may comprise any kind of structure or material as long as they are capable of providing support to the respective horizontal portions of a bib that they are designed to hold and are foldably connected to each other. For example, these two supports may be made of different materials and do not have to be in direct contact with each other, as long as there is a connection which permits relative movement, including folding, between the two. Furthermore, the supports for holding the respective portions of the bib do not need to be planar. For example, the pair of supports may be in the form of foldable frames (e.g., wire frames) with hollow and/or volumetrically curved bodies. In addition, the foldable bib display apparatus may comprise more than two foldably connected supports for holding respective portions of a bib. In other words, the foldable bib display apparatus may be capable of folding the bib in thirds at two or more folding lines and displaying it in such folded condition. For example, the foldable bib display apparatus may comprise three foldably connected supports, thereby enabling folding of the bib along two folding lines (for example, substantially in thirds) for economical storage and display. The present invention does not limit the number of folding lines or the manner of folding the bib, as long as the bib display apparatus permits repeated folding and unfolding of the bib it holds and displays.

It should be noted that the structure of the foldable bib display apparatus 20 described above may also be used to hold and display any foldable, substantially flat garment item other than a bib, such as a T-shirt, in a folded condition.

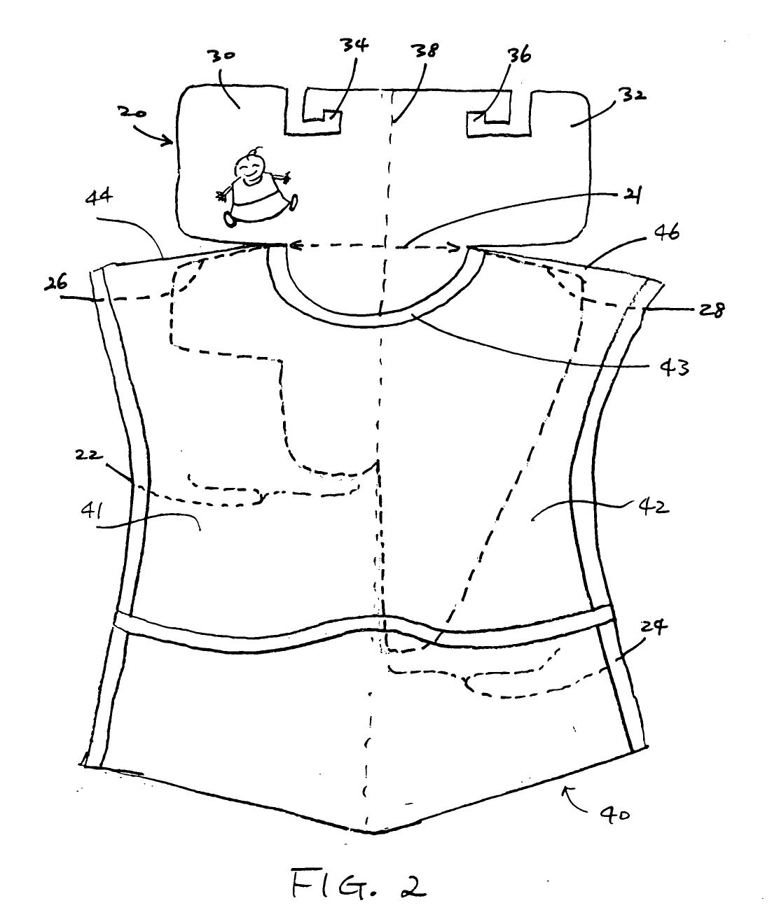

FIG. 2 shows the foldable bib display apparatus 20 when a bib 40 is placed on and fitted onto the bib display apparatus 20 in horizontal orientation. The bib illustrated in FIG. 2 has two shoulder portions 44 and 46 and a neck hole 43. As shown in FIGS. 1 and 2, the support for holding the horizontal half 41 of the bib 40 may be provided by an edge 26 of the first support 22 to support a shoulder portion 44 of the bib 40. Likewise, the support for the other horizontal half 42 of the bib 40 may be provided by an edge 28 of the second support 24 to support the other shoulder portion 46 of the bib 40. In other words, these edges 26 and 28 of the first and second supports 22, 24, respectively, provide hanger-like support to the bib 40. As shown in FIG. 2, these edges 26, 28 may be straight and horizontally oriented. However, as long as they can provide stable hanger-like support for holding the bib 40, these edges 26, 28 may be sloped or of any other operable form or shape.

A neck portion 21 of the foldable bib display apparatus 20 is defined by an area of the bib display apparatus between the inner-most ends of the edges 26, 28 of the first and second supports 22 and 24, respectively, and is designed to fit into the neck hole 43 of the bib 40. Preferably, the width of the neck portion 21 corresponding to the neck hole 43 of the bib 40 is substantially equal to the diameter of the neck hole 43 of the bib 40 so that the neck hole 43 of the bib 40 fits snugly into the foldable bib display apparatus 20 as shown in FIG. 2.

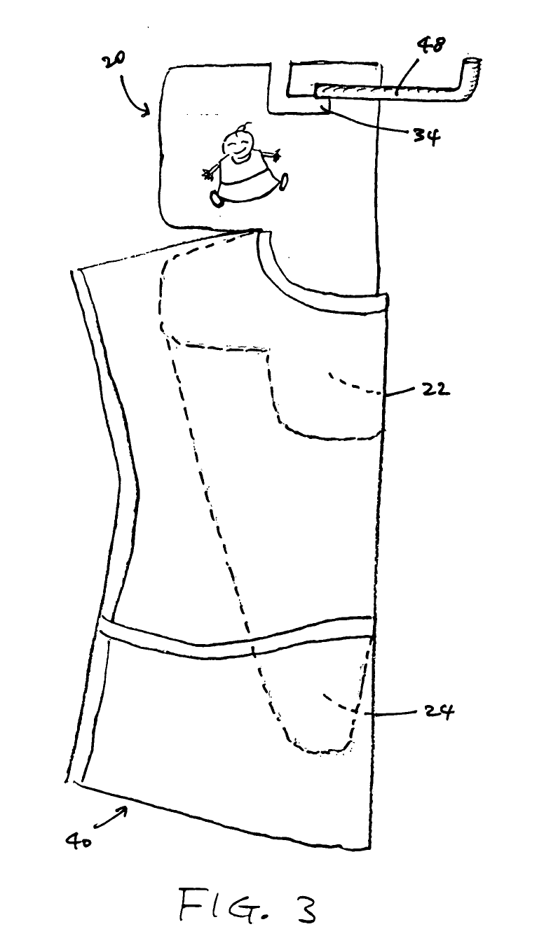

Referring again to FIG. 1, openings 34, 36 may be provided in one or both of the first and second supports 22, 24 for mounting the foldable bib display apparatus 20 onto a display rack or otherwise positioning the apparatus 20 in display space in its folded condition. As shown in FIG. 1, the opening 34, 36 may be “J”-shaped. However, any other form or structure may be used as long as it would permit mounting of the foldable bib display apparatus 20 onto a display rack in its folded condition or otherwise position the foldable bib display apparatus 20 holding a bib in a folded condition in a display space. For example, instead of a J-shaped opening, the foldable bib display apparatus of the present invention may have a projecting hook or a hook-like structure extending from one or both of the supports 22, 24. FIG. 3 shows the foldable display apparatus 20 with the bib 40 placed on it in horizontal orientation, mounted on a display rack in a folded condition and suspended from a bar 48 of the display rack through the J-shaped opening 34.

One or both of the supports 22, 24 of the foldable bib display apparatus 20 may further include a frontal area 30, 32 on a portion of the supports for displaying information, such as a product illustration or advertisement, product information, a picture of the bib in its unfolded condition, etc. In general, as shown in FIG. 3, the first support 22 is constructed and arranged so as to be facing toward prospective customers when mounted on a display rack and showing the frontal area 30 for displaying the information contained therein. As shown in FIG. 1, the frontal areas 30, 32 for displaying information may also include the openings 34, 36 for mounting onto a display rack. However, this is not required or necessary in accordance with the present invention.

A customer encountering a bib 40 placed on the foldable bib display apparatus 20 and displayed in its folded condition on a display rack as shown in FIG. 3 may unmount it from the display rack, unfold it along with the bib display apparatus 20 and view it in its unfolded condition as shown in FIG. 2. After the inspection, the customer or a store employee may easily re-fold the bib 40 along with the bib display apparatus 20 and re-mount it onto the display rack in a folded condition as shown in FIG. 3.

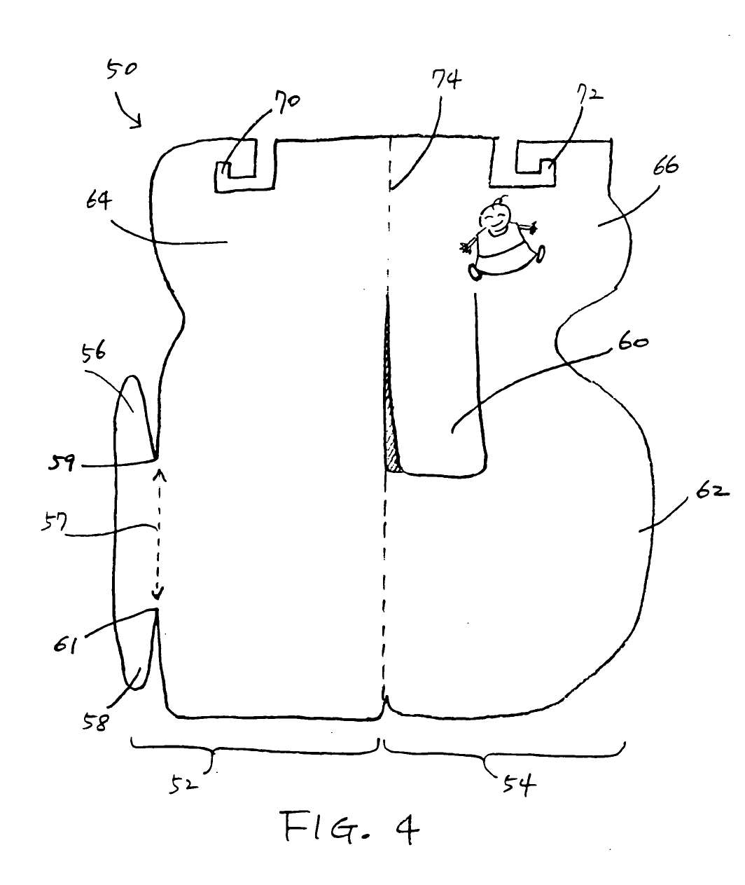

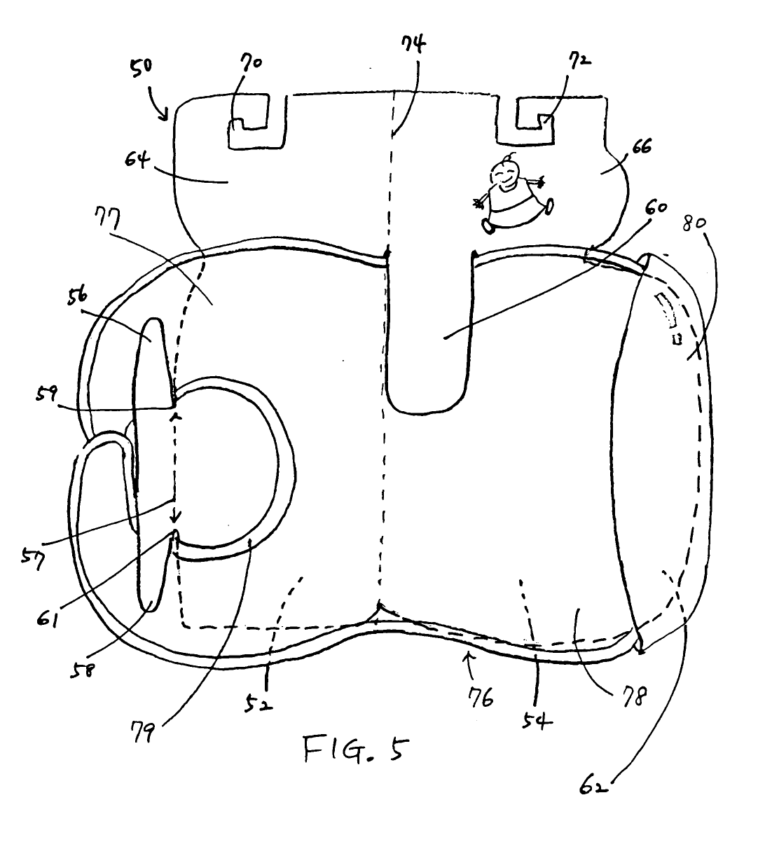

Referring now to FIG. 4 containing a front view of another embodiment of the present invention, a foldable bib display apparatus designed to hold and display a bib in vertical orientation is generally shown in unfolded condition and designated by its reference numeral 50. A bib may have a detachable pocket 80 to catch food crumbs as shown in FIG. 5. Such pocket of the bib is often made of or in close association with inflexible plastic and therefore itself unfoldable. Hence, a foldable bib display apparatus designed to hold and display such a bib vertically (i.e., in foldable orientation) may be especially desirable. The foldable bib display apparatus 50 comprises a first support 52 for holding a vertical half of the bib. The first support 52 is foldably connected at folding line 74 to a side of a second support 54 for holding the other vertical half of the bib. Preferably, the connecting part between these two supports 52, 54 at the folding line 74 is capable of withstanding repeated folding and unfolding at the folding line 74. For example, the supports 52, 54 may be made out of a single sheet of durable cardboard paper, a plastic sheet, or any other durable material capable of withstanding repeated folding and unfolding at the folding line 74. Alternatively, one or more mechanical hinges of conventional design may be used at the folding line 38 and affixed to the respective supports 52, 54 to foldably connect these two supports 52, 54.

As in the FIG. 1 embodiment, while FIG. 4 shows the pair of supports 52, 54 comprising a single, contiguous plane made out of the same material, the supports in accordance with the present invention may comprise any kind of structure or material as long as they are capable of providing support to the respective vertical portions of a bib that they are designed to hold, and are foldably connected to each other. For example, these two supports may be made of different materials, and do not have to be in direct contact with each other, as long as there is a foldable connection between the two. Furthermore, the supports for holding their respective portions of a bib do not need to be planar. For example, the supports may be in the form of foldable frames (e.g., wire frames) with hollow or curved bodies. In addition, the foldable bib display apparatus may comprise more than two foldably connected supports for holding respective portions of a bib. In other words, the foldable bib display apparatus may be capable of folding the bib it holds and displays at two or more folding lines. For example, the foldable bib display apparatus may comprise three foldably connected support, thereby enabling folding of the bib at two folding lines (for example, substantially in thirds) for display. The present invention is not limited to a particular number of folding lines or the manner of folding the bib, as long as the bib display apparatus is capable of repeatedly folding and unfolding the bib it holds and displays.

FIG. 5 shows the foldable bib display apparatus 50 when a bib 76 is placed and fitted onto the bib display apparatus 50 in vertical orientation. The support for holding a top of vertical half 77 of the bib 76 may be provided by a pair of tabs or wings 56 and 58 extending upward and downward, substantially in parallel, from the ends 59 and 61 of a neck portion 57 of the first support 52, respectively. Since these tabs or wings are designed to hold the respective opposite sides of a neck hole 79 of the bib 76, the width of the neck portion 57 of the first support 52, which is generally defined to be the distance between the ends 59 and 61 of the neck portion 57, is preferably substantially equal to or smaller than the diameter of the neck hole 79 of the bib 76 so that the neck hole 79 of the bib 76 can fit snugly onto the foldable bib display apparatus 50 as shown in FIG. 5. The distance between the neck portion 57 and a planar insert 62 of the foldable bib display apparatus 50 is such that, while the neck portion holds the neck hole 79 of the bib 76, the planar insert 62 can hold the bib pocket 80, as further described below.

The second support 54 for holding the bottom vertical half of the bib may be structured in various ways. For a bib with a detachable pocket 80 for catching food crumbs as shown in FIG. 5, the support for the bottom vertical half 78 of the bib 76 may be provided by a planar insert 62, which is extended from, or is a part of, the second support 54 and can be tucked into the backside of the pocket 80. The planar insert 62 preferably has a shape and size substantially same as those of the backside of the bib pocket 80 so that the planar insert 62 can fit snugly into the backside of the bib pocket 80.

An additional or alternative support for the bottom half 78 of the vertically oriented bib 76 may be provided by a tab 60 extending downward from the top portion of the second support 54 near the folding line 74. Although not shown in FIG. 5, additional downward tabs may be provided at various distances from the folding line 74 to supplement the support provided by the tab 60. As shown in FIG. 5, when the bib 76 is fitted onto the foldable bib display apparatus 50, the tab 60 is placed over a portion of the bottom vertical half 78 of the bib 76 so as to help the bottom vertical half 78 of the bib 76 resist disengagement from the second support 54 of the foldable bib display apparatus 50.

Although not shown in the drawings, another additional or alternative support for the bottom vertical half 78 of the bib 76 may also be provided by one or more tab extending upward from the bottom portion of the second support 54. When the bib 76 is fitted onto the foldable bib display apparatus 50, the tab is to be placed over a portion of the bottom vertical half 78 of the bib 76 to help it resist disengagement from the second support 54 of the foldable bib display apparatus 50.

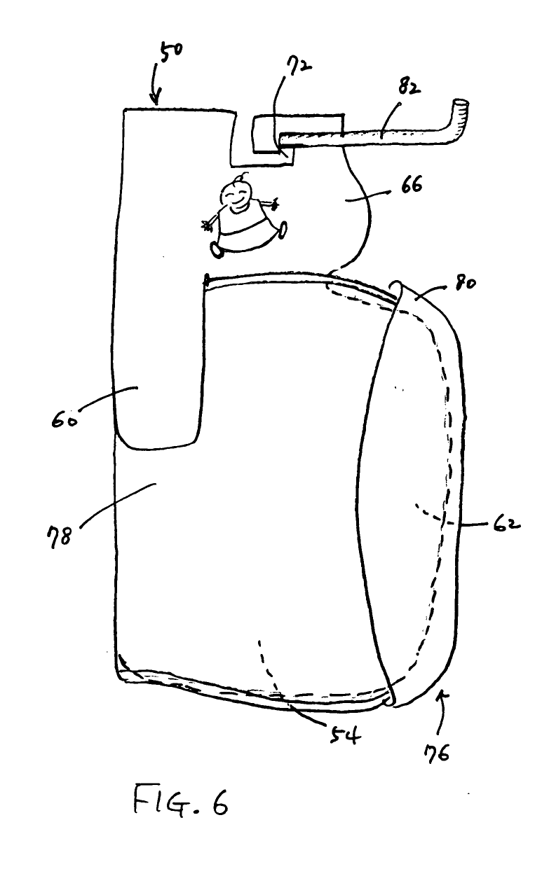

As in the foldable bib display apparatus for holding a bib horizontally as shown in FIG. 2, an opening 70, 72 of the foldably bib display apparatus 50 as shown in FIG. 4 may be provided in one or both of the supports 52, 54 to permit mounting of the foldable bib display apparatus 50 onto a display rack, or otherwise positioning the foldable bib display apparatus in display space, in folded condition. As shown in FIG. 4, the opening 70, 72 may be “J”-shaped. However, any other form or structure may be used as long as it would permit mounting of the foldable bib display apparatus 50 onto a display rack in folded condition or otherwise position the foldable bib display apparatus 50 holding a bib in a vertical orientation in such display space. For example, instead of an opening, the foldable bib display apparatus in accordance with the present invention may have a hook-like structure extended from and attached to one or both of the supports 52, 54. FIG. 6 shows the foldable display apparatus 50 holding the bib 76 in a vertical orientation, mounted on a display rack in folded condition and suspended from a bar 82 of the display rack through the J-shaped opening 72.

Also as in the foldable bib display apparatus for holding a bib horizontally as shown in FIG. 2, one or both of the first and second supports 52, 54 of the foldable bib display apparatus 50 may further include a frontal area 64, 66 on a portion of the supports, as shown in FIG. 4, for displaying information, such as a product illustration or advertisement, product information, a picture of the bib in its unfolded condition, etc. In general, as shown in FIG. 6, the support 54 for holding the corresponding portion of the bib facing toward prospective customers when mounted on a display rack would include the frontal area 66 on a portion of the support for displaying information. As shown in FIG. 4, the frontal area 64, 66 for displaying information may also include the opening 70, 72 for mounting onto a display rack and positioning the apparatus in a display space. However, this is not required or necessary in accordance with the present invention.

As with the foldable bib display apparatus 20 for holding a bib horizontally as shown in FIG. 2, a customer inspecting the bib 76 placed on the foldable bib display apparatus 50 for holding a bib vertically and displayed in its folded condition on a display rack as shown in FIG. 6 may unmount it from the display rack, unfold it along with the bib display apparatus 50 and view it in its unfolded condition as shown in FIG. 5. After the inspection, the customer or a store employee may easily re-fold the bib 76 along with the bib display apparatus 50 and re-mount it onto the display rack in its folded condition as shown in FIG. 6.

A support for holding a portion or all of the bib in either horizontal or vertical orientation may comprise various holding means other than the ones described above and illustrated in FIGS. 1-6. For example, holding means may be one or more clips attached in strategic locations to the support to hold portions of the corresponding folded sections of the bib. Alternatively, holding means may be provided by one or more hook-and-loop fasteners (such as Velcro-type fasteners) of suitable sizes placed in strategic locations to a support that would be in contact with the body of a bib, especially on its backside. The backside of a bib is typically made of, or faced with, cloth or a felt-like material, and therefore would be amenable to the use of hook fastening.

While the present invention has been described in the context of a foldable display apparatus for a bib, the present invention may likewise be applicable to other types of foldable and substantially flat garment such as a T-shirt.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

1. A foldable bib display apparatus for holding and displaying a bib in a folded condition to minimize display space for said bib, comprising:
a first means for holding a first portion of said bib;
a second means for holding a second portion of said bib; and
a hanger means for positioning said foldable bib display apparatus in folded condition for display,
wherein said first means and said second means for holding their respective portions of said bib are foldably connected to each other so that said foldable bib display apparatus when folded can hold and display said bib in a folded condition and can be repeatedly unfolded to facilitate inspection of said bib and re-folded for return to display.

2. The apparatus of claim 1, further comprising a third means for holding a third portion of said bib, wherein said third means is foldably connected to one or more of said first means and said second means for holding their respective portions of said bib so that said foldable bib display apparatus when folded can hold and display said bib in a folded condition and can be repeatedly unfolded to facilitate inspection of said bib and re-folded for return to display.

3. The apparatus of claim 1, further comprising a frontal area for displaying information on a portion of said apparatus.

4. The apparatus of claim 3, wherein said information is an illustration.

5. The apparatus of claim 1, wherein said first portion of said bib comprises substantially a half of said bib so that said foldable bib display apparatus in a folded condition can hold and display said bib folded substantially in half.

6. The apparatus of claim 2, wherein each of said first and said second portions of said bib comprises substantially a third of said bib so that said foldable bib display apparatus in a folded condition can hold and display said bib folded substantially in thirds.

7. The apparatus of claim 1, wherein said first and said second means for holding their respective portions of said bib are designed to hold their respective portions of said bib horizontally.

8. The apparatus of claim 1, wherein said first and said second means for holding their respective portions of said bib are designed to hold their respective portions of said bib vertically.

9. The apparatus of claim 2, wherein said first, said second and said third means for holding their respective portions of said bib are designed to hold their respective portions of said bib horizontally.

10. The apparatus of claim 2, wherein said first, said second and said third means for holding their respective portions of said bib are designed to hold their respective portions of said bib vertically.

11. The apparatus of claim 1, wherein said first means for holding said first portion of said bib comprises one or more clips.

12. The apparatus of claim 1, wherein said first means for holding said first portion of said bib comprises one or more hook-and-loop fasteners.

13. The apparatus of claim 1, wherein said hanger means comprises one or more hooks.

14. The apparatus of claim 1, wherein said hanger means comprises an opening in at least one of said first and second means for holding their respective portions of said bib.

15. The apparatus of claim 14, wherein said opening is “J”-shaped.

16. The apparatus of claim 1, wherein said first and said second means for holding their respective portions of said bib are foldably connected by one or more mechanical hinges affixed between said first and said second means for holding their respective portions of said bib.

17. The apparatus of claim 7, wherein said bib comprises a first shoulder portion and a second shoulder portion, and said first and said second means for holding their respective portions of said bib form a foldable hanger for supporting said first and said second shoulder portions of said bib, respectively.

18. The apparatus of claim 8, wherein said first means for holding said first portion of said bib comprises a back and one or more tabs extending from said back, whereby said one or more tabs provide support for holding said first portion of said bib when placed over said first portion of said bib.

19. The apparatus of claim 8, wherein said bib includes a neck-hole portion, and said first means for holding comprises means for holding said neck-hole portion of said bib.

20. The apparatus of claim 19, wherein said means for holding said neck-hole portion of said bib comprises an upward tab and a downward tab extending upwardly and downwardly, respectively, from a neck portion of said first means for holding said first portion of said bib corresponding to said neck-hole portion of said bib, wherein the width of said neck portion is substantially the diameter of said neck-hole of said bib.

21. The apparatus of claim 8, wherein said bib includes a pocket portion, and said first means for holding said first portion of said bib comprises a means for holding said pocket portion of said bib.

22. The apparatus of claim 21, wherein said means for holding said pocket portion of said bib comprises an insert for fitting into a backside of said pocket portion of said bib.

23. The apparatus of claim 3, wherein said first and said second means for holding their respective portions of said bib, said hanger means and said frontal area are made from cardboard.

24. The apparatus of claim 1, wherein said first and said second means for holding their respective portions of said bib comprise said hanger means.

25. The apparatus of claim 3, wherein said first means for holding said first portion of said bib comprises said frontal area for displaying information.

26. A bib display apparatus for holding and displaying a bib in a folded condition to minimize display space for said bib, comprising:
a means for holding said bib, wherein said means for holding said bib is designed to hold said bib in both a folded and an unfolded condition;
a means for permitting repeated folding and unfolding of said bib held by said means for holding said bib, wherein said means for permitting repeated folding and unfolding facilitates display and inspection of said bib; and
a means for positioning said bib in a folded condition in display space.

27. The apparatus of claim 26, further comprising a means for displaying information on a portion of said apparatus.

28. The apparatus of claim 26, wherein said means for holding comprises a plurality of foldably connected means for holding their respective portions of said bib, and said means for permitting repeated folding and unfolding comprises foldable connections affixed between said plurality of foldably connected means for holding their respective portions of said bib.

29. The apparatus of claim 28, wherein said plurality of foldably connected means for holding comprises:
a first means for holding a first portion of said bib; and
a second means for holding a second portion of said bib.

30. The apparatus of claim 26, wherein said means for positioning said bib in a folded condition comprises a hanger means.

31. The apparatus of claim 27, wherein said means for displaying information comprises a frontal area of said portion of said apparatus.

32. The apparatus of claim 27, wherein said information is an illustration.

33. The apparatus of claim 26, wherein said means for holding said bib is designed to hold said bib horizontally.

34. The apparatus of claim 26, wherein said means for holding said bib is designed to hold said bib vertically.

35. The apparatus of claim 26, wherein said means for permitting repeated folding and unfolding is designed to fold said bib substantially in half.

36. The apparatus of claim 26, wherein said means for permitting repeated folding and unfolding is designed to fold said bib along one folding line.

37. The apparatus of claim 26, wherein said means for permitting repeated folding and unfolding is designed to fold said bib along two or more folding lines.

38. The apparatus of claim 26, wherein said means for holding said bib comprises one or more clips.

39. The apparatus of claim 26, wherein said means for holding said bib comprises one or more hook-and-loop fasteners.

40. The apparatus of claim 30, wherein said hanger means comprises one or more hooks.

41. The apparatus of claim 30, wherein said hanger means comprises an opening in said means for holding said bib.

42. The apparatus of claim 41, wherein said opening is “J”-shaped.

43. The apparatus of claim 28, wherein said foldable connections comprise one or more mechanical hinges.

44. A foldable display apparatus for holding and displaying a garment in a folded condition to minimize display space for said garment, comprising:
a means for holding said garment, wherein said means for holding said garment is designed to hold said garment in both a folded and an unfolded condition;
a means for permitting repeated folding and unfolding of said garment held by said means for holding said garment, wherein said means for permitting repeated folding and unfolding facilitates display and inspection of said garment; and
a means for positioning said garment in a folded condition in display space.

45. The apparatus of claim 44, further comprising a means for displaying information on a portion of said apparatus.

46. The apparatus of claim 44, wherein said garment is a T-shirt.
